(19) United States
(12) Patent Application Publication
(10) Pub. No.: US 2002/0125821 A1
(43) Pub. Date: Sep. 12, 2002

(54) Electroluminescent display formed on glass with a thick film dielectric layer

(75) Inventors: Andrew J. Steckl, Cincinnati, OH (US); Jason C. Heikenfeld, Cincinnati, OH (US)

Correspondence Address: Wood, Herron & Evans, L.L.P., 2700 Carew Tower, 441 Vine Street, Cincinnati, OH, 45202-2917, US

(73) Assignee: University of Cincinnati

(21) Appl. No.: 09/804,211

(22) Filed: Mar. 12, 2001

(51) Int. Cl. H01J 1/62; H01J 63/04

(52) U.S. Cl. 313/506; 313/512

(57) ABSTRACT

Wide band gap semiconductor materials doped with rare earth form alternating current electroluminescent devices. The semiconductors are preferably gallium nitride, indium nitride or aluminum nitride and the electric luminescent device may have an upper and lower thin coat of a dielectric material in turn connected to alternating current electrodes. In a preferred embodiment, the electroluminescent device is formed on a glass substrate coated with a thick film of dielectric. The dielectric can be applied as a gel and heat treated after coating the semiconductor material to form a light emitting device.

### BACKGROUND OF THE INVENTION

The next generation of flat panel displays is seeking to provide advances in brightness, efficiency, color, purity, resolution, scalability, reliability and reduced costs. One such technology is thin film electroluminescence (TFEL) inorganic phosphors. TFEL displays can provide high brightness, outstanding durability and reliability. Current inorganic TFEL phosphors are composed of group II-VI wide band gap semiconductor hosts such as zinc sulfide and strontium sulfide which provide hot carriers (greater than two electron volts) which impact luminescent centers such as manganese, cerium, and copper.

Sufficient hot carrier generation requires high field strength exceeding the break down field of the phosphor thin film. An alternating current biased dielectric/phosphor/dielectric layered structure allows reliable high field operation by current limiting of the electrical breakdown of the phosphor layer. Generally these dielectric layers are thin film dielectric layers which are applied by sputtering or the like. As such, the thickness of the dielectric layers is generally limited. Due to the thinness of such dielectric layers any irregularities such as pinholes can result in premature electrical breakdown of the dielectric layers. This requirement for an irregularity-free thin film places different constraints on the deposition equipment and surrounding cleanliness if adequate yields are to be achieved.

One way to evaluate the performance of a dielectric layer is to calculate its figure of merit i.e., the product of dielectric constant and electrical breakdown field. Thin film dielectrics generally have a figure of merit (˜10-100) which is one magnitude lower than the figure of merit (˜100-1000) for thick film dielectric layers based on materials containing primarily ferroelectric ceramics along with glass or fluxing agents which facilitate lower temperature (<900° C.) sintering of the dielectric layer. There are thick film dielectrics which can be formed at temperatures lower than 600° C. but they suffer from a low figure of merit (10 to 100).

These thicker dielectric layers can be applied in the neighborhood of 10-100 microns. At such thickness the thick film dielectric layer is not susceptible to premature electrical breakdown due to uniformity irregularities which would cause a thin film dielectric to break down. Furthermore, thick film dielectrics also possess the advantage of application by screen printing, which is a simple, high yield, and easily scaleable process.

The thick film dielectrics generally must be screen-printed as a paste and subsequently sintered at high temperature in order to bring about desired dielectric properties. However, this sintering of the dielectric layer generally exceeds the breakdown temperature of the phosphor layer. Thus in order to utilize a thick dielectric layer, one must apply the dielectric layer to the electroluminescent device and anneal this layer prior to application of the phosphor layer. This then requires that the phosphor layer be applied to the thick dielectric film whose surface is generally irregular and not necessarily suitable for formation of an electroluminescent device. Therefore, the surface of the thick film dielectric must be smoothed by an additional planarization layer, such as sol-gel dip-coating, before the thin film phosphor layer is deposited.

Forming this electroluminescent device on, and emitting light through, a standard flat panel display substrate is not possible since the thick dielectric film layer is semi-transparent at best. This approach for forming the thick dielectric layer before thin film phosphor layer deposition has been patented (U.S. Pat. No. 5,756,147) and is being pursued for commercialization of flat-TVs among other information display products.

### SUMMARY OF THE INVENTION

The present invention is premised on the realization that with proper selection of material and implementation of phosphor and dielectric material, an electroluminescent device utilizing a thick film dielectric layer can be formed on and emit through a glass substrate. More particularly the present invention is premised on the realization that high temperature stable phosphor can be formed on a glass substrate prior to formation and sintering of a thick film dielectric layer. The high temperature required for the sintering of the dielectric does not adversely impact the semiconductor phosphor of the present invention. This permits the use of the present invention for electroluminescent flat panel display devices using relatively inexpensive technology.

The objects and advantages of the present invention will be further appreciated in light of the following detailed description and drawings in which:

### BRIEF DESCRIPTION OF THE DRAWINGS

FIG. 1 is a cross-section of an alternating current electroluminescent device using a phosphor layer that is formed on a ceramic substrate.

FIG. 2 is a cross-section of an alternating current electroluminescent device of the present invention, which allows light emission through a glass substrate.

FIG. 3 is a cross-section of an alternate embodiment of the present invention.

FIG. 4 is a cross-section of an alternate embodiment of the present invention (figure is attached at end of this document).

FIG. 5 is a graph of brightness vs. applied voltage obtained from the electroluminescent device of the present invention.

### DETAILED DESCRIPTION

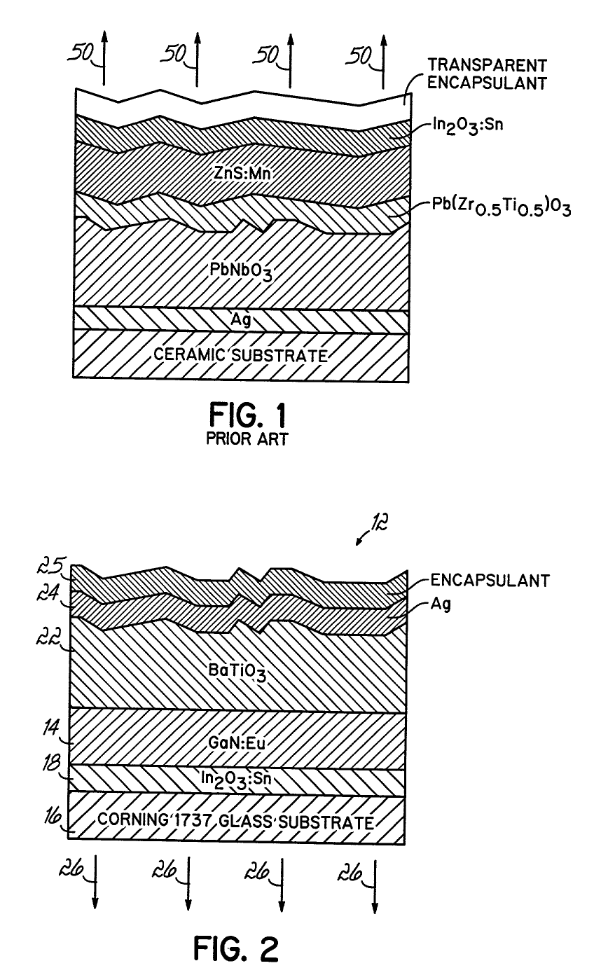

As shown in FIG. 2, an electroluminescent device 12 of the present invention has electroluminescent phosphor 14 applied over a glass substrate 16. In this embodiment, the initial substrate 16 is simply a glass substrate such as Corning 1737 glass substrate. Other high temperature glasses such as fused silica can be utilized.

Substrate 16 is coated with a first transparent followed by the high temperature stable electroluminescent phosphor 14.

Suitable transparent electrodes include metal oxides such as zinc oxide, tin oxide, indium oxide and mixtures thereof. Preferably for use in the present invention, the phosphor layer 14 will be gallium nitride doped with transition or rare earth metal. However, for this application it can be other high temperature stable phosphors that can withstand the high temperatures of and byproducts produced during sintering of the thick film dielectric layer. These would include phosphors such as aluminum gallium nitride, aluminum indium oxide, gallium oxide, zinc silicate/germanate, and zinc gallates. This would also include zinc and strontium sulfides if they are annealed in order to stabilize their structural integrity, then encapsulated with protective barriers, followed by deposition and sintering of the thick film dielectric layer significantly below the temperature at which the phosphor layer was annealed.

The high temperature electroluminescent phosphor is covered with a thick coating 22 of dielectric. Thick dielectric films are generally greater than 5 microns preferably 10 microns or more and in particular are applied by physical coating methods as opposed to chemical (i.e., gas phase or plasma phase) coating methods. The dielectric layer is applied as a gel. The preferred method of applying the dielectric is simply screen printing. Alternate methods include spraying, sol-gel dip-coating, and tape casting. The thick-film dielectric layer can also be formed by multiple dip coatings (up to 10 microns) of lead zirconate titanate sol-gel which requires a final firing temperature of ˜700° C. in order to achieve a permittivity of ε>500 preferably ε˜1000. A reduced dielectric firing temperature would also allow for compatibility with a larger variety of electroluminescent phosphors. Thus, the thick film dielectric must be one which can be sintered at a temperature which will not cause a breakdown in the phosphor or glass and which possess the requisite electrical properties.

Suitable dielectrics include but are not limited to barium titanate, lead zirconate titanate, and lead niobate. Some dielectrics such as barium titanate have additional glass and fluxing agents which facilitate low temperature (<900° C.) sintering and densification of the dielectric layer.

Dielectric layer 22 once applied is then heated up briefly to densify the dielectric, preferably at a temperature below the strain temperature of the glass substrate. Barium titanate is preferably heated to about 600° C. for 10 minutes. Following densification additional layers of barium titanate can be applied and densified. This is followed by a very brief sintering at 800-850° C. for 1-10 minutes. The dielectric layer 22 is coated with a metal electrode 24 by means of screen printing or other suitable method and is in turn coated with an encapsulant 25 such as Dupont 8185 or Honeywell Aclar film.

When alternating current is applied between the first electrode 18 and the rear electrode 22, light will be emitted from the layer phosphor 14 through the indium-tin-oxide 18 and through the glass 16 as indicated by arrows 26.

This structure has the advantage that without any additional processing to the lower surface the phosphor is applied to a relatively smooth surface as opposed to the much rougher surface found when forming a thick film dielectric layer before phosphor layer deposition. It further reduces processing steps and requires a minimum of only one dielectric. Further, the dielectric has significantly greater effectiveness than can be practically achieved using two thin layer dielectrics.

Although the transparent surfaces underlying the phosphor layer are generally considered smooth in comparison to the surface of the thick film dielectric layer, slight roughness of the glass and transparent electrode surfaces can improve the device efficiency and brightness. Surface roughness of the transparent electrode on the order of 100 nm allows for light to be scattered out of the light emitting phosphor more efficiently than the case of a light emitting phosphor which is in contact with perfectly smooth transparent electrode. The present invention allows for such roughening of the transparent electrode or underlying glass substrate since the 10 to 100 μm thick dielectric layer is reliable at high voltages for surface roughness values even about 1 μm. Such is not the case for thin film dielectrics where 100 nm surface roughness would adversely effect the high voltage reliability of the 200-400 nm thin film dielectric.

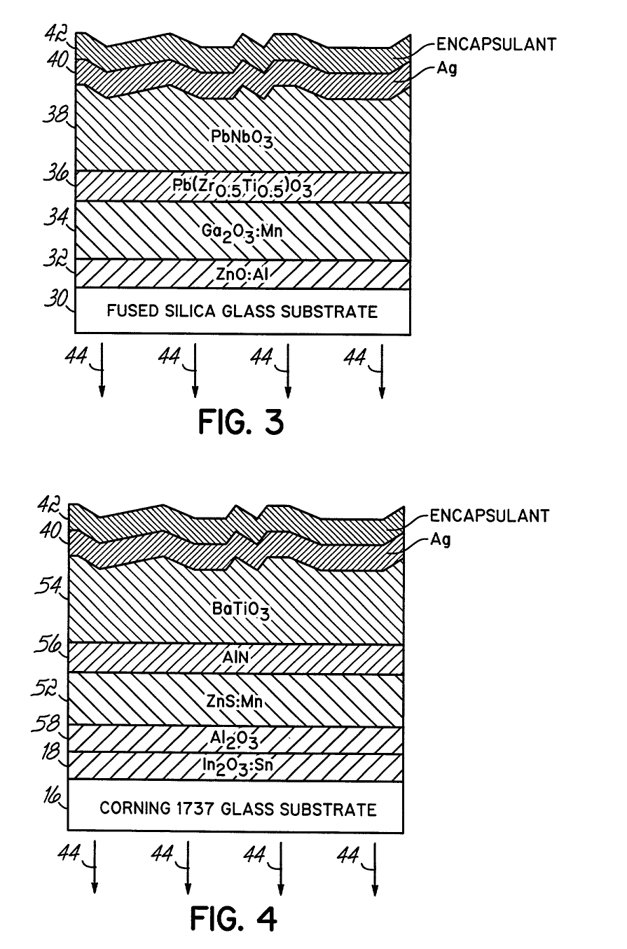

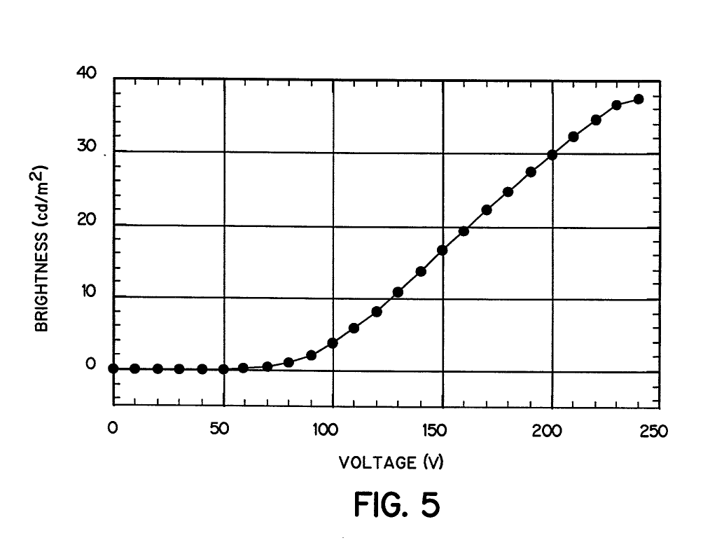

FIG. 3 shows a slightly modified embodiment of the invention. Shown in FIG. 3, the glass substrate 30 is coated with a transparent zinc oxide aluminum electrode 32 in turn coated with a high temperature gallium-based phosphor 34. This is coated with a thin dielectric 36 (0.1 to 1 micron) followed by a thick dielectric 38. The thin dielectric allows ones to modify the surface roughness of the phosphor layer to optimize diffuse outcoupling of the emitted light. The thin dielectric film 36 is applied by sputtering or the like as is the phosphor 34 as previously described. The thick film dielectric 38 is then applied using a screen printing technique followed by sintering and screen printing of a silver electrode layer 40. This can then be covered with a well-known encapsulant 42. In this embodiment likewise once current supply between the silver electrode 42 and the aluminum electrode 32, the phosphor 34 film will be excited causing it to fluoresce and emitting light as indicated by arrows 44.

The thick film dielectric layer allows formation of a high yield, high capacitance, and high voltage stable device structure. An additional thin film dielectric (not shown) may be inserted between the phosphor layer 34 and transparent front electrode 32 with a different primary purpose than that served by the thick film dielectric layer. Sputtering of an A1₂O₃ thin film dielectric is an example of such a thin film dielectric (0.1 to 1 microns). This transparent thin film dielectric layer can result in improved efficiency and brightness of the device through charge trapping of electrons at the phosphor/thin film dielectric interface. The effects of the dielectric/phosphor interface on device performance is well known by those skilled in the art.

The embodiment shown in FIG. 1 is a prior art embodiment which demonstrates the disadvantages of the prior art utilizing thick film dielectrics. As shown with both the embodiments in FIGS. 2 and 3, the phosphor layers are applied on a very smooth surface providing significant uniformity. Further, they are applied on or adjacent to glass substrates so that the emission is directly through the original substrate on which the phosphor is deposited. FIG. 1 depicts a prior art structure in which an additional intermediate planarization layer (lead zirconium titanium oxide) is included. This layer is required because the roughness of the underlying thick dielectric is of the order of the thickness of the phosphor layer and would result in non-uniform emission (dark spots). Therefore, the prior art has the disadvantage of a more complicated fabrication sequence. Further, the light, as indicated by arrows 50, is emitted through an irregular surface which is less preferred.

The present invention can utilize the thick film dielectric layer of the present invention because of the chemical and structural stability of the GaN-based phosphor layer. The light emitting performance of the GaN phosphor layer is not adversely affected by the high temperature or reactive by-products produced during sintering of the thick film dielectric layer. As shown in FIG. 4, the present invention can be utilized with phosphors 52 that are structurally but not chemically stable at the required sintering temperature of the thick film dielectric layer 54. In order to prevent phosphor layer 52 degradation due to reactive by-products produced during dielectric sintering, a thin film protective barrier 56 may be placed between the structurally stable phosphor layer and thick film dielectric. An example of such a protective barrier is AlN which can be sputtered onto the phosphor layer. The present invention can also be utilized with phosphor layers which, as deposited, are neither chemically or structurally stable at the required sintering temperature of the thick film dielectric layer. Phosphors such as ZnS:Mn and SrS:Ce are examples. Such phosphor layers must first be made structurally stable at the sintering temperature of the dielectric layer. Then a protective barrier must be placed over the phosphor layer. Without structural stability, the integrity of the protective barrier is compromised during sintering of the thick film dielectric layer. To complete such a structure, ZnS:Mn 52 is sputtered at near room temperature (over thin said layer 58), then annealed at or above the sintering temperature of the thick film dielectric layer. This anneal allows for structural stability of the ZnS:Mn phosphor layer at high temperature. After anneal, an AlN protective barrier 56 can be applied to the ZnS:Mn phosphor layer. The thick film dielectric layer 54 is then screen printed and sintered at a temperature which is near or below the annealing temperature of the ZnS:Mn phosphor layer. This embodiment allows the use of less stable phosphors in a structure which emits light through a transparent glass substrate.

The invention will be further appreciated in light of the following examples.

### EXAMPLE 1

Dupont 9970 Ag:Pt paste was screen printed onto alumina substrates, dried, and fired at 850° C. for ten minutes. One or two layers of Dupont 5540 dielectric paste were screen printed, dried and sintered at 850° C. for ten minutes. The 5540 paste contains barium titanate along with glass or fluxing agents that facilitate lower temperature (<900° C.) sintering of the dielectric. A scanning electron microscope photograph showed that the thick-film dielectric layer has a surface roughness of ˜1 micron and is granular with high porosity. The resulting dielectric layer thickness was 20-40 microns with a permittivity of ε˜6000. A GaN:Er phosphor film of ˜1 micron thickness was then deposited by solid-source molecular beam epitaxy onto the dielectric/metal/ceramic substrates. ˜300 nm thick indium-tin-oxide transparent electrodes were then sputtered through a stencil mask onto the GaN:Er phosphor film. The resulting structure was biased with a 1 kHz, 200V square wave and exhibited a low luminance of <1 cd/m². The poor luminance was due to the roughness of the thick-film dielectric layer on which the GaN:Er phosphor layer was deposited. Also, since both the dielectric layer, Ag:Pt metal electrode, and ceramic substrate were opaque, light emission was not possible through the substrate.

### EXAMPLE 2

˜300 nm indium-tin-oxide films were deposited on Corning 1737 glass substrate which has a thermal strain point of 666° C., sufficiently above the ˜600° C. substrate temperature used during gallium nitride phosphor deposition. Corning 1737 is a widely utilized display glass due to its compatibility with low temperature (500-600° C.) poly-Si processing used for active-matrix liquid crystal displays. Approximately 1 micron thick erbium doped gallium nitride phosphor film was deposited by solid-source molecular beam epitaxy onto the indium-tin-oxide coated 1737 glass substrates. Following phosphor deposition, 1 layer of Dupont 5540 dielectric paste was screen printed, dried, densified for 10 minutes at ˜600° C., and sintered at ˜800° C. for 4 minutes. The resulting dielectric layer had a thickness of ˜20 microns, breakdown strength >200 V, and permittivity of ε˜500-1000. Rear electrodes were formed by sputtering of tantalum through a stencil mask.

A scanning electron microscope photograph of the completed device showed that the underlying phosphor and transparent electrode layers were structurally intact after sintering the dielectric layer. When viewed under a high magnification microscope, the light emission from the electroluminescent device is uniform well below 10 microns, which is beyond the requirements of a flat panel display. When biased with an alternating voltage source, the erbium doped gallium nitride electroluminescent device exhibited a green emission with a maximum luminance value of ˜20 cd/m² at 200 V, 1 kHz biasing. Unlike the device of Example 1, this brightness value is sufficient for a flat panel display. Accelerated aging tests of the electroluminescent device resulted in a 60 Hz operational lifetime in excess of 1000 hrs at >50% initial brightness.

### EXAMPLE 3

A device similar to that of Example 2 was formed with the following changes to fabrication of the thick-film dielectric layer. Following the phosphor deposition, 1 layer of Dupont 5540 dielectric paste was screen printed, dried, densified for 1 minutes at ˜600° C. A second layer of Dupont 5540 dielectric paste was then screen printed, dried, and densified for 10 minutes at ˜600° C. This stock of two dielectric layers was then sintered at ˜800° C. for 4 minutes. The resulting dielectric layer had a thickness of ˜40 microns, breakdown strength >300 V, and permittivity of ε˜500-1000. The device exhibited similar luminance characteristics to that of Example 2 but showed improved reliability at high voltages (>300 V breakdown).

### EXAMPLE 4

A device structure similar to that of Examples 2 and 3 was formed with an approximately 1 micron thick europium-doped gallium nitride phosphor film deposited onto an indium-tin-oxide coated 1737 glass substrate. When biased with an alternating voltage source, the completed europium-doped gallium nitride electroluminescent device exhibited a deep red emission with a maximum brightness value of ˜40 cd/m² at 200 V, 1 kHz biasing.

### EXAMPLE 5

In place of the Ta electrodes utilized in Examples 2-4, an Ag thick-film back electrode was screen printed and dried. The resulting device structure exhibited similar luminance values to those obtained in Examples 2-4 but required no vacuum processing of the rear electrode.

The present invention can then be used to form a flat screen display device by simply forming red, green and blue electroluminescent devices adjacent to each other. Basically tens to millions of the electroluminescent devices would be formed over an area preferably utilizing the embodiment shown in FIGS. 2 and 3. This would then enable a flat screen display device such as a television, computer monitor or the like. Further, the cost and yield of manufacturing is significantly improved due to the ability to screen print the dielectric onto the structure. Further, utilizing the thick dielectric film significantly enhances the reliability of the electroluminescent device of the present invention.

This has been a description of the present invention along with a preferred method of practicing the invention. However, the invention itself should be defined only by the appended claim, wherein we claim:

1. An alternating current electroluminescent device comprising a transparent substrate, a visible light emitting phosphor over to said substrate and adapted to emit light through such substrate, a thick film dielectric covering a rear surface of said phosphor and separating said phosphor from a rear electrode wherein said thick dielectric has a thickness greater than 5 microns.

2. The electroluminescent device claimed in claim 1 wherein said light emitting phosphor is formed from a first element selected from group II, III and IV of the periodic chart and a second element selected from group V and VI of the periodic chart.

3. The electroluminescent device claimed in claim 2 further comprising a transparent electrode between said transparent surface and a front surface of said phosphor.

4. The electroluminescent device claimed in claim 3 further comprising a thin film dielectric between said phosphor and said thick film dielectric.

5. The electroluminescent device claimed in claim 2 further comprising a thin film dielectric between said transparent surface and a front surface of said phosphor.

6. The electroluminescent device claimed in claim 2 wherein said phosphor is a doped compound selected from the group consisting of gallium nitride, aluminum gallium nitride, aluminum indium oxide, gallium oxide, zinc silicate/germanate, zinc gallate, zinc sulfide and strontium sulfide.

7. The electroluminescent device claimed in claim 1 wherein said phosphor is a material which does not break down at a temperature of 500° C.

8. The method of forming an electroluminescent device comprising coating a transparent substrate with a high temperature resistant visible light emitting phosphor;
applying a thick film dielectric of at least 5 microns over said phosphor;
heating said structure to a temperature effective to crystallize said dielectric; and
coating said dielectric with a rear electrode.

9. The method claimed in claim 8 wherein said temperature is at least 500° C.

10. The method claimed in claim 9 wherein said dielectric has a permittivity greater than 500.

11. The method claimed in claim 8 wherein said substrate comprises a first transparent layer covered with a transparent front electrode.

12. The method claimed in claim 11 wherein said thick film dielectric is first heated to a first temperature effective to cause said dielectric to densify and subsequently heated to a second temperature effective to sinter said dielectric.

13. The method claimed in claim 12 wherein a first dielectric layer is applied and heated to said first temperature and a second dielectric layer is applied to said first dielectric layer and heated to said first temperature and wherein said combined first and second layers are subsequently heated to said second temperature.

14. The method claimed in claim 8 wherein said rear electric has a thickness greater than 5 microns.

15. The method claimed in claim 14 wherein said rear electrode is applied by screen printing.

16. The method claimed in claim 8 further comprising coating said rear electrode with an encapsulant.

17. The method claimed in claim 9 wherein said phosphor is a compound selected from the group consisting of gallium nitride, aluminum gallium nitride, aluminum indium oxide, gallium oxide, zinc silicate/germanate, zinc gallate, zinc sulfide and stronium sulfide.

18. The method claimed in claim 8 wherein said thick film dielectric has a thickness of from about 10 to about 100 microns.

19. The method claimed in claim 11 wherein said transparent electrode is coated with a thin film dielectric having a thickness of from 0.1 to 1 micron.

20. The method claimed in claim 8 further comprising applying a thin film dielectric layer having a thickness of about 0.1 to about 1 micron between said phosphor and said thick film dielectric.

21. The method claimed in claim 8 wherein said phosphor is first coated with a thin film dielectric selected from the group consisting of lead zirconate titanate, and lead lanthanum zirconate titanate.

22. The method claimed in claim 11 wherein said transparent electrode is a metal oxide.

23. The method claimed in claim 22 wherein said metal oxide is selected from the group consisting of ZnO, indium oxide, tin oxide and combinations thereof.

24. A flat display screen comprising a plurality of electrodes adjacent to each other so that the electrodes in adjoining layers having a structure defined in claim 1.

25. A method of forming an electroluminescent device comprising
coating, a transparent substrate with a light emitting phosphor;
coating said phosphor with a protective layer;
applying a layer of dielectric to said protective layer wherein said layer of dielectric has a thickness of about 5 microns;
heating said dielectric layer to a temperature effective to crystallize said dielectric;
wherein said protective coating is effective to protect said phosphor layer when said dielectric is heated; and
applying a rear electrode to said dielectric layer.

26. The method claimed in claim 25 wherein said temperature is at least about 500° C.

27. The method claimed in claim 25 wherein said first substrate comprises a transparent layer covered with a transparent front electrode.

28. The method claimed in claim 27 wherein said protective layer is selected from the group consisting of titanium nitride and aluminum nitride.

29. The method claimed in claim 27 wherein said rear electrode is applied by screen printing.

30. The method claimed in claim 27 further comprising coating said rear electrode with an encapsulant.
